(19) United States
(12) Patent Application Publication
(10) Pub. No.: US 2007/0022190 A1
(43) Pub. Date: Jan. 25, 2007

(54) METHOD FOR ACCESS MANAGEMENT

(75) Inventors: Robert BRASEGARD, Molndal (SE); Marko VAINIO, Harestad (SE)

Correspondence Address: NOVAK DRUCE & QUIGG, LLP, 1300 EYE STREET NW, 400 EAST TOWER, WASHINGTON, DC, 20005, US

(73) Assignee: VOLVO LASTVAGNAR AB, Goteborg (SE)

(21) Appl. No.: 11/470,205

(22) Filed: Sep. 5, 2006

Related U.S. Application Data
(63) Continuation of application No. PCT/SE05/00301, filed on Mar. 2, 2005.

(30) Foreign Application Priority Data
Mar. 3, 2004 (SE) 0400545-0

(51) Int. Cl. G06F 15/173

(52) U.S. Cl. 709/223

(57) ABSTRACT

Method for accessing management for a portal. The method includes obtaining user-specific data from a policy store and accessing an application with the user-specific data. The application is activated with the user-specific data and late binding is used. This method allows for simple and robust authorization on demand.

### CROSS-REFERENCE TO RELATED APPLCIATIONS

The present application is a continuation patent application of International Application No. PCT/SE2005/000301 filed 2 Mar. 2005 which is published in English pursuant to Article 21(2) of the Patent Cooperation Treaty and which claims priority to Swedish Application Nos. 0400545-0 filed 3 Mar. 2004. Said applications are expressly incorporated herein by reference in their entireties.

### TECHNICAL FIELD

The present invention relates to a method for access management on a portal on the Internet.

### BACKGROUND OF THE INVENTION

Identity management and access management are new concepts on the Internet, containing functionality as e.g. single-sign-on and authentication. The need for these new concepts is arising out of an enormous amount of possible users that are reached when companies put their core applications in a portal for easy access on the Internet. It is difficult for the companies to find a single strategic solution to handle all these users because market leaders and standard communities propose different, diverging approaches, and new actors and solutions are still entering the market and challenging commonly used standards such as LDAP (Lightweight Directory Access Protocol) and active directory.

In the early 1990's many companies developed an administration system for users on a global scale, e.g. with login and authorization. All these systems are locally installed on servers and computers. Every single user and/or connected computer requires a specific installation and adaptation of the system, which has to be performed locally. When new http-based clients on the Internet became a possibility in the late 1990's, these administration systems were still able to cope with the new limited numbers of clients.

Since then, an explosion of new users and new applications has appeared, turning the issue of handling authorization and roles for each user on each application into a major problem. This problem is partly due to the fact that many companies are using more and more web-based applications and more and more applications are made available through the Internet. This problem is commonly referred to as the Million User Problem (MUP). The MUP clearly shows that traditional user administration systems are not sufficient to handle all users at a portal.

Another problem is different cultural and decision-making processes in different countries that must be handled in the same system.

The traditional user administration concept is a facility to set authorization for users in a single application. It can be hard to administrate, e.g. 100 applications in different environments as AS400, OS390, UNIX, Windows, and so on. The traditional way to administrate applications, by letting them administrate their authorities themselves, is not administratively acceptable on the Internet. The traditional solution will require a lot of man-time and economic resources because it is complex to administrate.

This concept is being replaced by a new expression, Identity management. This expression consists of two major parts, the authorization part and the authentication part, containing functionality as e.g. single-sign-on and authentication. Different approaches are known to handle a large number of users on an Internet portal with a high security level. These known solutions use the concept of early binding.

Early binding is a solution where all permissions, roles, and authorities are defined in advance. This is often done already when a user login to a portal or system. The policy store, in an early binding solution, set a cookie that includes all roles and permissions for the logged on user. This cookie is then sent with http-header to all links that are connected in the portal or system and can be read by anyone that is interested in the information. An example of information is e.g. which links that are allowed to be accessed by a specific user. The Public-key Infrastructure (PKI) technology is an example of early binding. This solution is sometimes referred to as the firewall solution and is shown in FIG. 1.

In the firewall solution, a firewall is used together with a module containing e.g. domains, roles, categories and actions using the approach of early binding. This module is sometimes referred to as a policy store. This solution gives a high security level and the possibility for all users on the same firewall to use information that are set by a cookie which is sent in the http-header to all links that are connected to the firewall. This solution is the most common on the market. The disadvantage is that large amount of data is sent between http-headers when new links are activated. Another disadvantage is that no relational database is used. This gives a static and inflexible way to set user attributes.

Another solution is bound to a single specific database. A database solution is shown in FIG. 2. In this solution, the database includes a module (policy store) containing e.g. domains, roles, categories and actions. This solution works well when all applications use the same database. For applications that use other databases, special solutions are required. The same applies to database solutions that must interact with other environments, e.g. when an application does not exist for the same environment. Another disadvantage is that all possible users have to be registered in the database, even if the user never or seldom accesses the portal. This registration will often require a license cost for each registered user.

The major drawback for these known solutions is that they cannot handle and adapt too many different users and applications in a flexible, interactive manner.

### SUMMARY OF THE INVENTION

The object of the invention is therefore to provide a method for improved access management that in a simple, robust and cost-effective manner can handle several users and applications.

With a method for access management for a portal, the problem is solved by the following steps: obtaining user-specific data from a policy store; accessing an application with the user-specific data; activating the application with the user-specific data; and, wherein late binding is used.

This first embodiment of the method according to the invention provides an access method in which an application is accessed with user-specific data using late binding. The purpose of this is to be able to use a standard application and to adapt it depending on the user accessing it, and at the same time provide for an easy and dynamic administration of all necessary attributes for a user in the late binding.

In an advantageous first development of the method, the relational model will also contain fine granular information for each interested party. The purpose of this is to make it possible to set authority on method level and field level for each user.

In an advantageous second development of the method, the method uses a combination of early and late binding. The benefit of this solution is an easy and dynamic administration of all necessary attributes for a user in the late binding combined with high security offered by the firewall through early binding.

### BRIEF DESCRIPTION OF THE DRAWINGS

The invention will be described in more detail below with reference to preferred embodiments as shown in the drawings attached, in which:

FIG. 1 shows a known access management system based on a firewall;

FIG. 2 shows a known access management system based on a database;

FIG. 3 shows a first embodiment of an access management system according to the invention; and

FIG. 4 shows a second embodiment of an access management system according to the invention.

### DESCRIPTION OF PREFERRED EMBODIMENTS

The preferred embodiments of the invention and developments described below must be regarded solely as examples and in no way limit the scope of the patent claims.

This application concerns a method for access management for a portal on the Internet. Access management is a part of the identity management, which also contains the authentication part. The authentication is handled by a firewall. The access management described in this application does not concern the firewall itself, but is intended to be able to run at any firewall.

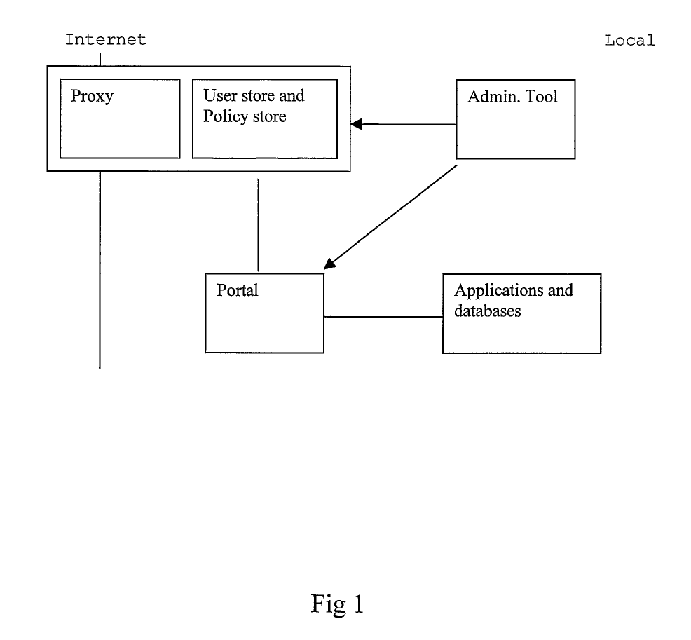

FIG. 1 shows a traditional access management system for a portal based on a firewall where a software module is connected to the firewall. This module, referred to as a policy store, contains all user attributes e.g. domains, roles, categories and actions for each user that is allowed to enter the portal. The access is handled by the LDAP standard. The firewall can be either a hardware firewall or a software firewall or a combination of these.

Domains provide a hard firewall limitation to access a URL outside the domain. This will prevent users from accessing an application outside the domain even if he knows the complete URL and this is a necessary security facility on a firewall.

Since the LDAP standard does not have a natural administration facility, a special administration tool must be used. All changes in the user profile, e.g. allowance to access new applications, must be stored in the policy store using the administration tool. The portal is any portal that is used by e.g. a company.

When the user is to log in to the portal through the Internet, the firewall with the policy store takes care of the identification and the authorization of the user. All the specific settings and attributes for that user are stored in the policy store and are used when the user accesses the portal.

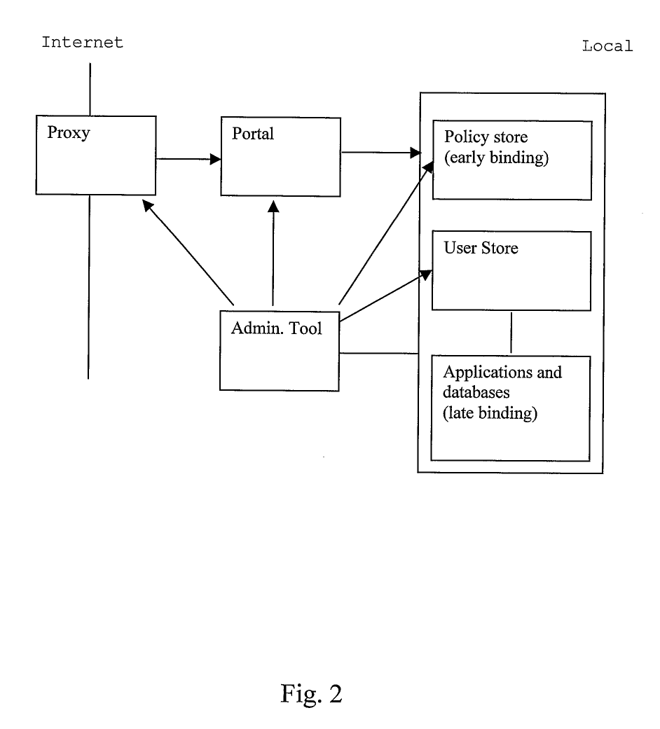

FIG. 2 shows a traditional access management system based on a database. This is a good solution when one specific database is used for all applications on a portal. In this solution, the policy store is included in the database allowing all database securities and facilities to be used to secure actions in the system. This solution also uses triggers on the database level to set filter and other user-specific attributes.

This solution offer is a high security. A disadvantage is that all users need to be registered in the database. The registration of users must be done even if the user never or seldom accesses the portal. This will give a license cost for each registered user. This solution also incorporates a user administration system. A special modification of the access management system is required every time an application that does not exist in the same environment is to be accessed.

These known solutions are based on the concept of early binding as described above.

The method of the access management system according to the invention makes use of late binding. Late binding permits more dynamic actions to be taken during processing instead of relying on the ability to map out every possibility in advance. Rule-processing engines examine and evaluate user attributes and make decisions directly.

In a first preferred embodiment of an access management system according to the invention, an access method using late binding is provided. This embodiment allows for authorization on demand for a user. A relational object model is adopted to hold all user profiles, authorities, and filters in the late binding. The benefit of this solution is an easy and dynamic administration of all necessary attributes for a user in the late binding. The relational model will also contain fine granular information for each interested party and this will make it possible to set authority on method and field level for each user.

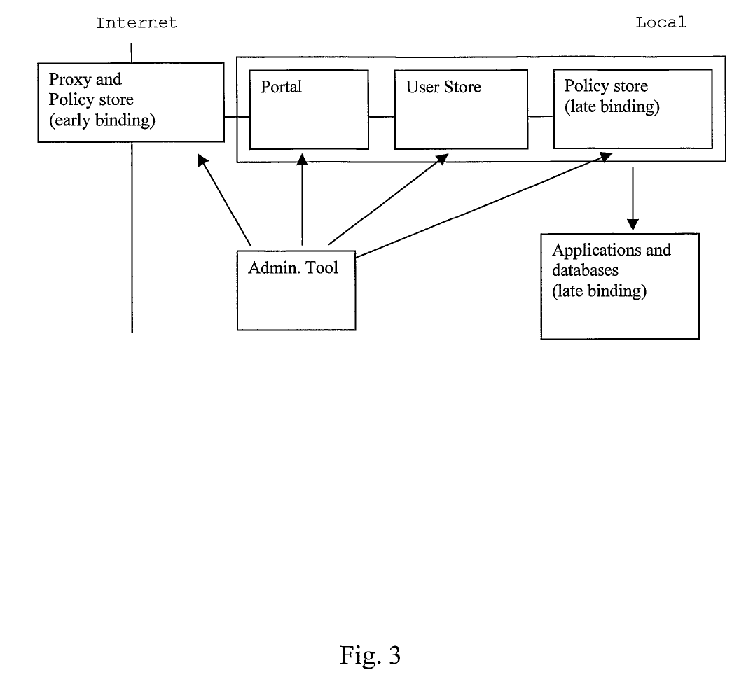

In this embodiment, the policy store of the access management system is separated from the firewall and from the databases used by the portal. All user attributes, e.g. domains, roles, categories, and actions are stored in the policy store. A schematic of this embodiment is shown in FIG. 3. In this policy store, user attributes are saved in a fine granular level. By fine granular level, it is meant that all different definitions for a user and/or application, down to a very detailed level, can be specified. This means, e.g. that when a user enters a specific application, all his preferred settings are activated. This can include the allowed actions for that user, the background color, language, etc. Other possible definitions for a user can be a filter for information that shall be viewed for a specific user and to hold user profiles and links that should be viewed for the user on a portal. This model creates a dynamic view on a portal for a specific user and gives him a personalized look of the portal.

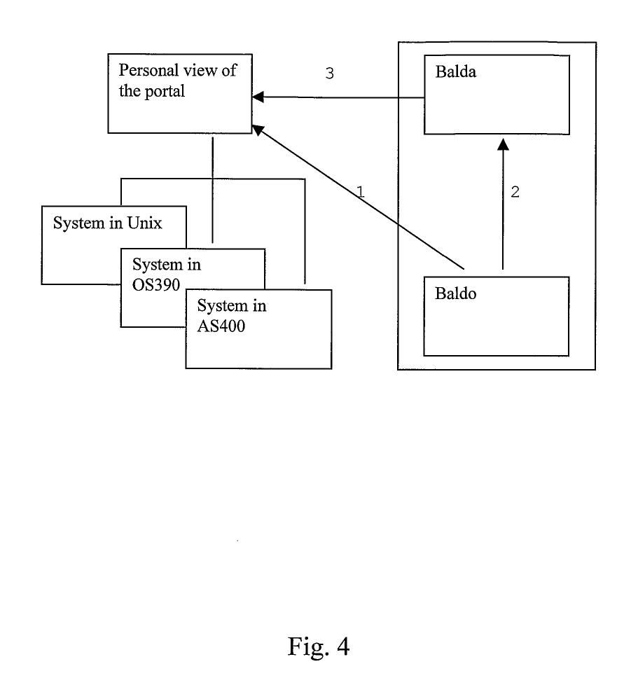

FIG. 4 illustrates another embodiment of the invention. A function, here named Baldo, stores user and organization structures. Another function, Baldo Late Binding, here named Balda, stores instructions to other applications and to Baldo itself. FIG. 4 illustrates how a portal or an application are coupled to and receive instructions from Baldo. The portal itself can request information from the organizational structure if needed (arrow 1).

The user administrator sets authorities for a specific user/application (arrow 2). This includes the allowed access information for a specific user and a particular application. The allowed access information includes, e.g. what the specific user is allowed to see for the particular application and what actions the specific user is allowed to perform when using the particular application.

Late Binding (arrow 3) gives instructions to the application link activated from either a portal or a direct access function. This interaction, i.e. the use of late bindings to instruct the application link, requires that the specific application is adapted to accept instructions on this level. The application is therefore preferably designed such that it is adapted to ask for instructions through a Late Binding module.

In another embodiment, the settings in Late Binding are distributed via a transaction to the local application. This is advantageous if the application is not adapted to ask for instructions through a Late Binding module. This functionality is preferred when the application is without control (i.e. when the system operator does not have access to the written system code) or is remote from the Late Binding module.

By using a Late Binding module as described here, an application can access each database with the same user through Baldo. This means that the database is accessed by a single user during every transaction. This single user is preferably a so-called super-user with an unlimited access to the database. The single user should at least have access to every part of the database that any of the specific users requests. The application will receive the instructions for how it will appear for the specific user directly from the Late Binding module. In this way, only the parts requested by the specific user are accessed by the single user.

The main advantage with the concept of Late Bindings is to give the user administrators one single tool to administrate all specific users independent of what environment they are processed in. This advantage is increased with the number of environments and the number of specific users. At the same time, only a single user license is required to access each database used.

An access to a portal performed by a user will be described by way of example.

First, the user reaches the firewall or the proxy by entering the address to the desired portal. At the proxy, the user enters his ID-number and password. The proxy performs an authentication control and if the user is allowed to enter the portal, the proxy sends e.g. the ID-number to the policy store to start the portal. The policy store receives the ID-number. The ID-number is used by the policy store to fetch the user profile for the user in a relation database so that the portal can start with the proper settings for the specific user. In this way, the policy store tells the portal which links should be active. This gives a user access to a specific link.

Only the links and applications that the specific user has access to will be activated and shown on the portal. This will thus set an authorization and a filter for each application at an http-page by sending instructions to each http-page, e.g. enable/disable buttons, methods and fields. Different personal settings for the specific user will also be activated, e.g. language etc. This means that the same portal will have a custom-made look for each user and that each user only will see links and applications available to him.

If the user is a car dealer for a specific market, he will e.g. only see the car models available on his market. Or a customer will only see available spare parts for models sold in that market. Also, the language and other market-specific entities, e.g. specific advertisement, will be set for that market.

When the user wants to start an application, he activates one of the allowed links. The application asks the policy store which authority, e.g., which buttons and fields, should be shown for that application, on the new page. The policy store fetches the proper authority string in the relation database and tells the application which actual authority that the user has. The application then shows the new page with the proper settings, i.e. buttons and links that the user is allowed to use on that page.

Since all user-specific settings for an application are handled by the policy store, there is no need for the database to be limited for each individual user or to store any user-specific data in the database. Instead, the portal can access the database as a super-user because the application itself has restricted the user access. The portal will, for each user, only fetch the data available to that specific user. This means that the database will only be accessed by one user, namely, the portal itself. Since the database only sees one user, the portal, there is no need for more than one license for that database. This in turn means that no matter how many users are accessing the database, only one license is required.

By using the inventive method, a company that is located all over the world can use the same databases and applications for all employees regardless of the country and the language for the user and the actual authority that the user has. One advantage is that applications only have to be developed once and all users can use a full version of the application. This is useful, e.g. when a user changes location or position in the company. The application will be the same, even though the accessed settings and the appearance of the application may change. Another advantage is that updates in the applications and databases will be introduced automatically, since e.g. a database is accessed by one user only, as a super user.

Categories and actions are normally handed over to the applications themselves. It is very difficult to administrate, e.g. 100 applications in different environments such as AS400, OS390, UNIX, Windows etc. The traditional way to administrate applications, by letting them administrate their authorities themselves, is not administratively acceptable on the Internet. The traditional solution will require a lot of man-time and economic resources because it is complex to administrate.

The method according to the invention does not use LDAP in the policy store. Instead, a relational object model is used to hold all user profiles, authorities and filters in the policy store. The benefit of this solution is an easy administration of all necessary attributes for a user. The relational model will also contain granular information for each HTTP link in a portal, and this makes it possible to set authority on method and field level for each user.

Roles are related to the user and will place him in his special area, e.g. a Car Dealer. Categories will be connected to a specific application and give a user a user-category on the application, e.g., read-only. Actions will make it possible for a user to perform action on each category on an application, e.g. delete, save, or update.

The inventive access management system is connected to a User-Administration-System. All users must be known by an i.d., in a user administration tool. After a Firewall and a User administration have been established, the policy store module in the access management system will handle all filters, authorities, and action on each link or application.

In known solutions, the suppliers put the policy store together with the firewall or together with the database. With the inventive solution, the policy store is put together with the user administration and the portal. With this solution, the user security is separated from the database and from the firewall. This solution makes it possible to run all users on a one-database-license and to run at any firewall that sets a user cookie.

This solution is supplier-independent and provides a more flexible and easily adjustable solution to system developers. It is also a much more economic solution than the traditional solutions with the policy store in the database or in the firewall.

In a second preferred embodiment of the access management method according to the invention, a single sign-on for a user at a portal is achieved. If a user has access to 20 applications, he does not want to log on every time he wants to start a new application. The policy store gives the portal information to access each application with the user-specific data. Therefore, there is no need for the application to store user-specific data or to incorporate a login procedure.

In a third preferred embodiment of the access management method according to the invention, a combination of early and late binding is used. A relational object model is adapted to hold all user profiles, authorities, and filters in the late binding, and a firewall with early binding is used for authorization. The benefit of this solution is an easy and dynamic administration of all necessary attributes for a user in the late binding and high security offered by the firewall through early binding. The relational model will also contain fine granular information for each HTTP link in a portal, and this will make it possible to set authority on method and field level for each user.

The invention must not be regarded as being limited to the preferred embodiments described above, a number of further variants and modifications being feasible without departing from the scope of the following claims.

What is claimed is:

1. A method for access management for a portal, comprising the following steps:
obtaining user-specific data from a policy store;
accessing an application with the user-specific data;
activating the application with the user-specific data and wherein late binding is used.

2. The method as recited in claim 1, wherein a relational object model is adopted that holds all user profiles, authorities and filters in the late binding.

3. The method as recited in claim 2, wherein the relational object model also contains fine granular information for each interested party.

4. The method as recited in claim 1, further comprising:
accessing a database from the application with user-specific data.

5. The method as recited in claim 1, further comprising:
accessing a database as a super-user.

6. The method as recited in claim 1, wherein said method is used for single sign on for a user who is allowed to access a plurality of applications.

7. The method as recited in claim 1, wherein a combination of early and late binding is used.

8. The method as recited in claim 1, wherein a firewall with early binding is used for authorization.

9. The method as recited in claim 2, further comprising:
accessing a database from the application with user-specific data.

10. The method as recited in claim 2, further comprising:
accessing a database as a super-user.

11. The method as recited in claim 2, wherein said method is used for single sign on for a user who is allowed to access a plurality of applications.

12. The method as recited in claim 2, wherein a combination of early and late binding is used.

13. The method as recited in claim 2, wherein a firewall with early binding is used for authorization.

14. The method as recited in claim 3, further comprising:
accessing a database from the application with user-specific data.

15. The method as recited in claim 3, further comprising:
accessing a database as a super-user.

16. The method as recited in claim 3, wherein said method is used for single sign on for a user who is allowed to access a plurality of applications.

17. The method as recited in claim 3, wherein a combination of early and late binding is used.

18. The method as recited in claim 3, wherein a firewall with early binding is used for authorization.

19. A computer program comprising program code for executing the following steps when the program is executed by a computer, said steps comprising: obtaining user-specific data from a policy store; accessing an application with the user-specific data; and activating the application with the user-specific data and wherein late binding is used.

20. Computer program product comprising program code stored on a medium that can be read by computer for carrying out the following steps when the program is executed by a computer, said steps comprising: obtaining user-specific data from a policy store; accessing an application with the user-specific data; and activating the application with the user-specific data and wherein late binding is used.
